(19) United States
(12) Patent Application Publication
(10) Pub. No.: US 2005/0015913 A1
(43) Pub. Date: Jan. 27, 2005

(54) Robot cleaner having a rotating wet cloth

(75) Inventors: Ki-Man Kim, Gwangju-city (KR); Ju-Sang Lee, Gwangju-city (KR); Jang-Youn Ko, Gwangju-city (KR); Jeong-Gon Song, Gwangju-city (KR)

Correspondence Address: BLANK ROME LLP, 600 NEW HAMPSHIRE AVENUE, N.W., WASHINGTON, DC, 20037, US

(73) Assignee: SAMSUNG GWANGJU ELECTRONICS CO., LTD.

(21) Appl. No.: 10/694,855

(22) Filed: Oct. 29, 2003

(30) Foreign Application Priority Data
Jul. 24, 2003 (KR) 10-2003-0051135

(51) Int. Cl. A47L 5/30

(52) U.S. Cl. 15/319; 15/385

(57) ABSTRACT

A vacuum cleaner with a rotatable wet cloth cleaning unit. The vacuum cleaner is capable of not only cleaning dust, but also removing stubborn dirt such as a foreign substance stuck in a floor surface to be cleaned. The robot cleaner has a robot cleaner body which as a control unit programmed to cause the robot cleaner to automatically run along a floor surface to be cleaned and perform a cleaning operation in accordance with preset values. The robot cleaner further includes a driving portion driven in accordance with a control signal from the control unit and a dust suction portion for capturing and collecting dust by a suction motor. The robot cleaner has a rotatable wet cloth cleaning unit detachably secured to a lower surface of the robot cleaner body.

### FIELD OF THE INVENTION

The present invention relates to a robot cleaner, and more particularly, to a robot cleaner which is capable not only of dry-type cleaning through a vacuum cleaning, but also of wet-type cleaning by employing a rotatable wet cloth which is attachable to, and detachable from the cleaner.

### BACKGROUND

As known in the art, a robot cleaner automatically runs along the floor surface of a room and cleans the area by drawing in dust and dirt from the surface.

FIGS. 1 and 2 show one example of such a robot cleaner, which will be briefly described below.

FIG. 1 is a perspective view illustrating a conventional robot cleaner from which a cover is separated. The reference numeral 10 denotes a robot cleaner body, 20 is a dust suction portion, 30 is a suction opening, 40 is a sensor portion, 50 is a control portion and 60 is a battery.

As shown, there are a plurality of driving wheels 11, 12 disposed at both sides of the robot cleaner body 10 for the locomotion of the robot cleaner. The root cleaner body 10 is substantially a circular plate, with a substantially hemispherical cover attached thereto. The cover is omitted in the drawing.

The dust suction portion 20 functions to draw in dust from the floor surface with a strong suction force that the dust suction portion 20 generates at a suction port (not shown) formed in the robot cleaner body 10. The dust suction portion 20 includes a vacuum motor collecting chamber (not shown) for collecting therein the dust which is drawn in through the suction port by the operation of the vacuum motor.

The suction opening 30 is formed in a lower surface of the robot cleaner body 10 in fluid communication with the suction port, and, within the suction opening 30, there is a rotatable brush 31 for ‘dusting off’ the floor surface to be cleaned.

The sensor portion 40 is disposed along a side of the robot cleaner body 10 at predetermined intervals to externally transmit signals and receive the reflected signals. The sensor portion 40 includes an obstacle sensor (not shown) and a moving distance sensor (not shown).

The control portion 50 processes the signals received at a transceiving portion thereof, and controls the respective components, respectively. More specifically, the control portion 40 receives signals from an external control apparatus or from a remote controller, and accordingly drives the driving wheels 11, 12 and the vacuum motor of the dust suction portion 20. Further, the control portion 50 controls the operation of the robot cleaner according to the signals received from the sensor portion 40.

The robot cleaner as described above can determine a distance to obstacles such as furniture, office machines, or walls, through the sensor portion 40, and selectively drive the driving wheels 11, 12 of the robot cleaner body 10 according to that determination. When necessary, the robot cleaner can also change the direction of motion.

However, the conventional robot cleaner as described above has a problem. That is, while the robot cleaner can remove dust with efficiency, it does not clean well the stubborn dirt such as foreign substance stuck in the floor surface to be cleaned. Accordingly, the user usually cleans the dust from the area first, and secondly, wipes the area in order to make sure that the stubborn dirt is also cleaned. As a result, it usually takes a long time to complete the cleaning, and the user has been inconvenienced in wiping the cleaning area with a wet cloth.

### SUMMARY OF THE INVENTION

The present invention overcomes the above-mentioned problems of the prior art, and accordingly, it is an object of the present invention to provide a robot cleaner of improved structure, which is capable not only of cleaning dust from a floor surface to be cleaned, but also of removing stubborn dirt such as foreign substance stuck in the floor surface by using a detachable wet cloth.

In an effort to solve the problems described above, it is an aspect of the present invention to provide a robot cleaner, which includes a robot cleaner body, and a rotatable wet cloth cleaning unit detachably secured to a lower surface of the robot cleaner body. The robot cleaner body has a control unit programmed to cause the robot cleaner to automatically run along a floor surface to be cleaned and perform a cleaning operation in accordance with preset values, a driving portion driven in accordance with a control signal from the control unit, and a dust suction portion for capturing and collecting dust by a suction motor.

The rotatable wet cloth cleaning unit includes a rotatable wet cloth cleaning unit body, a rotary body rotatably disposed on a lower end of the rotatable wet cloth cleaning unit body to which a wet cloth is detachably attached. A rotation driving means is included to provide a driving force for rotating the rotary body during an operation of the robot cleaner. A driving force transmitting unit is mounted in the rotatable wet cloth cleaning unit body with one end attachable and detachable with respect to the rotation driving means, and wherein the driving force transmitting unit is used for transmitting the driving force of the rotation driving means to the rotary body.

The rotation driving means has a bi-directional rotation motor which has a pair of rotation axes protruding from both ends for rotating in the same direction. The driving force transmitting unit has a worm wheel gear connected to the rotary body and a worm gear member having a worm gear portion engaged with the worm wheel gear. An engaging portion is provided to one end for screw-fastening with the rotation axes of the rotation driving means, and a support portion formed at the other end of the engaging portion.

A male thread is formed on an outer circumference of the engaging portion of the rotation axes, and a female thread is formed on an end of the rotation axes or the engaging portion where the male thread is not formed.

The respective threads formed on the engaging portion and the rotation axes are left-hand threads so that fastening is accomplished when the rotation axes rotate in clockwise direction. Also, the respective threads formed on the engaging portion and the rotation axes are right-hand threads so that fastening is accomplished when the rotation axes rotate in counterclockwise direction.

The engaging portion and the support portion are respectively supported on a support bracket which protrudes from a lower surface of the rotatable wet cloth cleaning unit body. The support bracket has a seating hole pierced therethrough to receive the engaging portion and the support portion, respectively.

### BRIEF DESCRIPTION OF THE DRAWINGS

The above aspects and other features of the present invention will become more apparent by describing in detail a preferred embodiment thereof with reference to the attached drawings, in which:

FIG. 1 is a perspective view of a conventional robot cleaner;

FIG. 2 is a bottom view of FIG. 1;

FIG. 3 is a perspective view of a robot cleaner according to a preferred embodiment of the present invention, employing a rotatable wet cloth cleaning unit;

FIG. 4 is a bottom exploded perspective view illustrating the robot cleaner according to the preferred embodiment of the present invention; and

FIG. 5 is an exploded perspective view of the robot cleaner according to the preferred embodiment of the present invention.

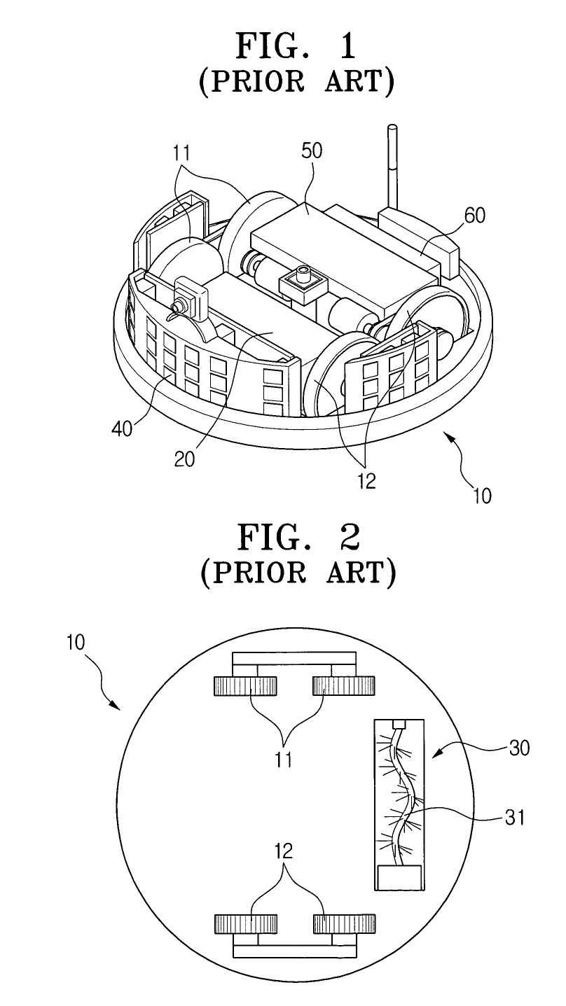

### DETAILED DESCRIPTION OF THE PREFERRED EMBODIMENTS

Hereinafter, the present invention will be described in detail with reference to the accompanying drawings.

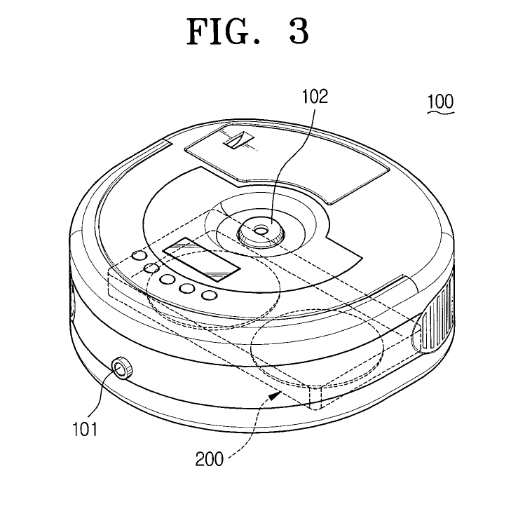

FIG. 3 is a perspective view of a robot cleaner according to a preferred embodiment of the present invention. A reference numeral 100 denotes a robot cleaner, 101 a front camera, 102 an upward camera, and 200 a rotatable wet cloth cleaning unit.

As shown, the robot cleaner 100 according to the preferred embodiment of the present invention determines location information based on the image information captured through the front and upward cameras 101, 102, and accordingly performs cleaning operation in accordance with predetermined programs of a control unit (not shown). The robot cleaner 100 has a rotatable wet cloth cleaning unit 200 which is detachably provided to a lower surface thereof.

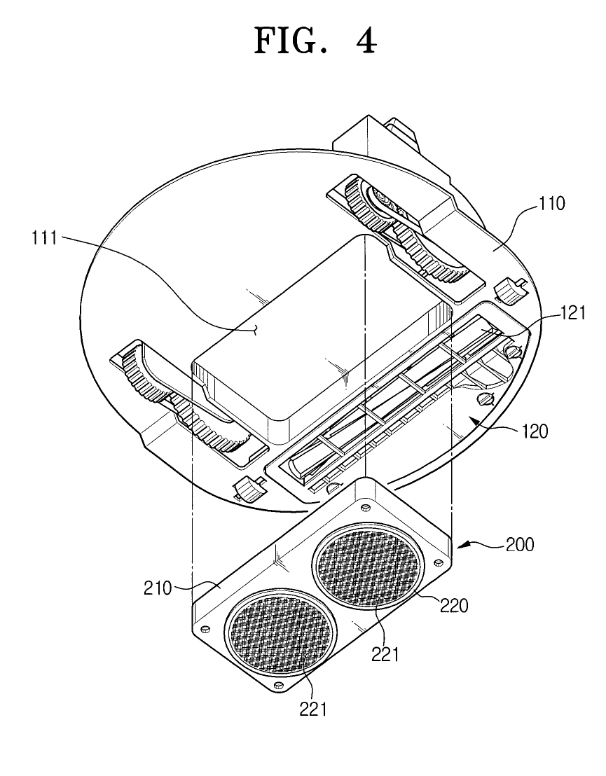

The rotatable wet cloth cleaning unit 200 is preferably provided in proximity to a brush frame 120 where a rotatable brush 121 is mounted. As shown in FIG. 4, it is also preferable that a space 111 corresponding in shape to the rotatable wet cloth cleaning unit 200 is defined in the robot cleaner body 110 to completely receive the rotatable wet cloth cleaning unit 200 therein.

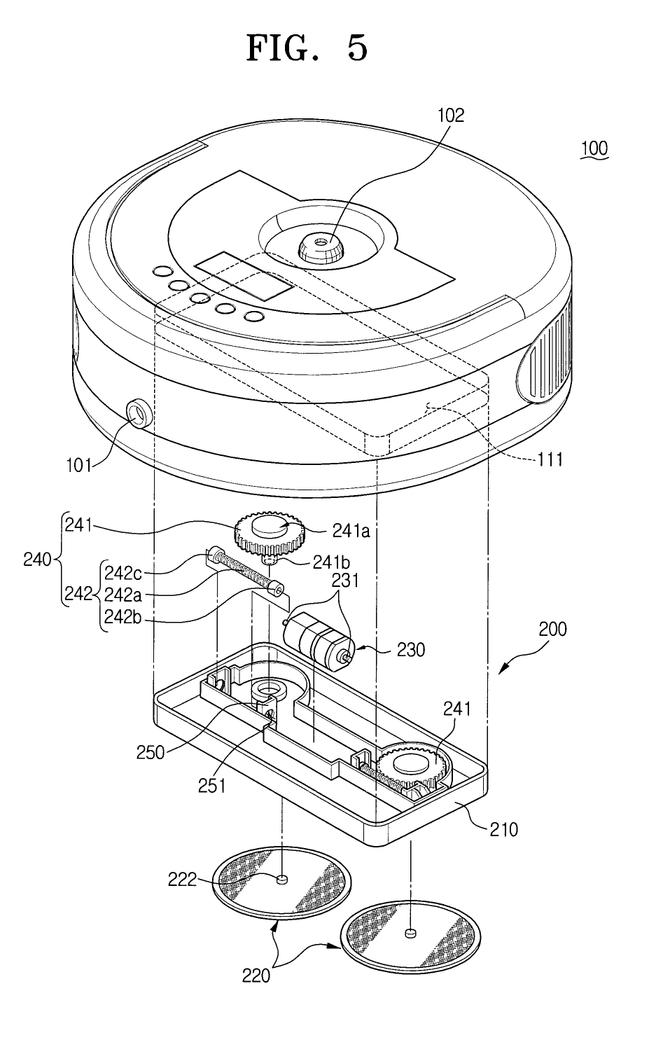

Referring to FIGS. 4 and 5, the rotatable wet cloth cleaning unit 200 includes a rotatable wet cloth cleaning unit body 210, a rotary body 220 rotatably disposed on a lower end of the rotatable wet cloth cleaning unit body 210 to which a wet cloth 221 is detachably secured and, a rotation driving means 230. The rotation driving means 230 provides a driving force for rotating the rotary body 220 during the operation of the robot cleaner 100. A driving force transmitting unit 240 is disposed in the rotatable wet cloth cleaning unit body 210 with one end attachable and detachable with respect to the rotation driving means 230, to transmit the driving force of the rotation driving means 230 to the rotary body 220.

The rotary body 220 takes a form substantially of a circular plate, to which the wet cloth 221 is detachably secured to a location opposing the surface to be cleaned. An engaging protrusion 222 protrudes approximately at the center of the rotary body 220 for the engagement of the rotary body 220 with a worm wheel gear 241 and rotating together. The wet cloth 221 may be detachably secured to the rotary body 220. For example, the wet cloth 221 may be attached to the rotary body 220 by Velcro, or wrapped around the rotary body 220.

The rotation driving means 230 may take a form of a bi-directional rotation motor which has a pair of rotation axes 231 protruding from both ends for rotating in the same direction.

The driving force transmitting unit 240 includes the worm wheel gear 241 engaged with the rotary body 220, and a worm gear member 242. The worm wheel gear 241 is engaged with the rotary body 220 through a connecting member 241a. The connecting member 241a includes a connecting hole 241b formed in one end to receive the connecting protrusion 222. According to the preferred embodiment of the present invention, the rotary body 220 and the worm wheel gear 241 are connected to each other by a ‘force-fitting’ of the connecting protrusion 222 with respect to the connecting hole 241b. However, this should not be considered as limiting. Various alternatives are possible, and for example, the rotary body 220 can be connected with the worm wheel gear 241 by other physical connecting means such as screws, or even chemical connecting means such as a bond.

The worm gear member 242 includes a worm gear portion 242a engaged with the worm wheel gear 241, an engaging portion 242b provided to one end for screw-fastening to the rotation axis 231 of the rotation driving means 230, and a support portion 242c formed at the other end of the engaging portion 232b. A male thread is formed on an outer circumference of the engaging portion 242b or of the rotation axis 231, and a female thread is formed on an end of the rotation axis 231 or the engaging portion 242b where the mail thread is not formed.

More specifically, the threads formed on the pair of engaging portions 242b, and the pair of rotation axes 231, may take a form of a left-hand thread so that the fastening can be made by the rotation of the rotations axes 231 in the clockwise direction, and a form of a right-hand thread so that the fastening can be made by the rotation of the rotation axes 231 in the counterclockwise direction. By doing this, screw-fastening of the engaging portion 242b due to the rotation of the rotation axes 231 is prevented from unfastening.

It is preferable that the engaging portion 242b and the support portion 242c are supported on a support bracket 250 which protrudes from the lower surface of the rotatable wet cloth cleaning unit body 210. The support bracket 250 has a seating hole 251 pierced therethrough, which receives the engaging portion 242b and the support portion 242c.

The operation of the robot cleaner with the rotatable wet cloth cleaning unit will be described below with reference to the preferred embodiment of the present invention and the accompanying drawings.

The robot cleaner 100 initiates the cleaning operation per a command from a user. The robot cleaner 100 acquires location information through the images captured through the front and upward cameras 101, 102 and runs along a floor surface to be cleaned in accordance with the programs predetermined in a control unit (not shown). As the suction motor installed inside the robot cleaner 100 operates, negative pressure generates inside the dust collecting chamber, and, due to the negative pressure, air, including ambient dust is drawn into the dust collecting chamber.

In addition to the operation of the robot cleaner 100, the rotation driving means 230 also starts the operation. Accordingly, the pair of rotation axes 231 connected to the rotation driving means 230 are rotated together. By rotation of the rotation axes 231, the worm gear member 242 screw-engaged with the rotation axes 231 is also rotated in the same direction. Also, the worm gear member 242 is engaged with the worm wheel gear 241, and accordingly, the worm wheel gear 241 is rotated in perpendicular relation with respect to the rotation direction of the worm gear member 242.

Accordingly, the rotary body 220 mounted on a lower end of the rotatable wet cloth cleaning unit body 210 and engaged with the worm wheel gear 241, receives the rotational force from the worm wheel gear 241, and thus rotates in the same direction as the worm wheel gear 241.

The wet cloth 221 is attached to the lower end of the rotary body 220, namely, by a Velcro fastener. Accordingly, the wet cloth 221 attached to the lower end of the rotary body 220 is also rotated together with the rotary body 220. The rotating wet cloth 221 successfully removes any stubborn dirt as the rotating wet cloth 221 contacts with the floor surface to be cleaned.

With the robot cleaner having the rotatable wet cloth cleaning unit according to the present invention, not only dust, but also, stubborn dirt such as a foreign substance stuck in the floor surface to be cleaned, can be efficiently removed. As a result, it is more convenient for a user to use the robot cleaner because he/she does not have to wipe the cleaning surface after the cleaning.

Although the preferred embodiments are described above for purposes of illustration and description, the invention is not to be considered limited by the above description, but is to be considered as including any modifications, changes and alterations, and the invention is to be limited only by the following claims.

1. A robot cleaner, comprising:
robot cleaner body comprising,
a control unit programmed to cause the robot cleaner to automatically run along a floor surface to be cleaned and perform a cleaning operation in accordance with preset values;
a driving portion driven in accordance with a control signal from the control unit, and
a dust suction portion for capturing and collecting dust by a suction motor; and
a rotatable wet cloth cleaning unit detachably secured to a lower surface of the robot cleaner body.

2. The robot cleaner of claim 1, wherein the rotatable wet cloth cleaning unit comprises:
a rotatable wet cloth cleaning unit body;
a rotary body rotatably disposed on a lower end of the rotatable wet cloth cleaning unit body, and to which a wet cloth is detachably secured;
a rotation driving means for providing a driving force for rotating the rotary body during an operation of the robot cleaner; and
a driving force transmitting unit mounted in the rotatable wet cloth cleaning unit body with one end attachable and detachable with respect to the rotation driving means, wherein the driving force transmitting unit is used for transmitting the driving force of the rotation driving means to the rotary body.

3. The robot cleaner of claim 2, wherein the rotation driving means comprises a bi-directional rotation motor which has a pair of rotation axes protruding from both ends for rotating in the same direction, and the driving force transmitting unit comprises:
a worm wheel gear connected to the rotary body; and
a worm gear member having a worm gear portion engaged with the worm wheel gear, an engaging portion provided to one end for screw-fastening with the rotation axes of the rotation driving means, and a support portion formed at the other end of the engaging portion.

4. The robot cleaner of claim 3, wherein a male thread is formed on an outer circumference of the engaging portion of the rotation axes, and a female thread is formed on an end of the rotation axes or the engaging portion where the male thread is not formed.

5. The robot cleaner of claim 4, wherein the respective threads formed on the engaging portion and the rotation axes are left-hand threads so that fastening can be made when the rotation axes rotate in clockwise direction.

6. The robot cleaner of claim 4, wherein the respective threads formed on the engaging portion and the rotation axes are right-hand threads to enhance fastening when the rotation axes rotation in counterclockwise direction.

7. The robot cleaner of claim 3, wherein the engaging portion and the support portion are respectively supported on a support bracket which protrudes from a lower surface of the rotatable wet cloth cleaning unit body.

8. The robot cleaner of claim 7, wherein the support bracket has a seating hole pierced therethrough to receive the engaging portion and the support portion, respectively.
